(19) United States
(12) Patent Application Publication
(10) Pub. No.: US 2004/0211719 A1
(43) Pub. Date: Oct. 28, 2004

(54) Unitary two stage filtration system

(76) Inventors: William P. Kearney, Kingston, NY (US); George T. Quigley, Cottekill, NY (US); Jack Cole, Huntington, NY (US)

Correspondence Address: JACOBSON HOLMAN PLLC, 400 SEVENTH STREET N.W., SUITE 600, WASHINGTON, DC, 20004, US

(21) Appl. No.: 10/420,890

(22) Filed: Apr. 23, 2003

(51) Int. Cl. B01D 29/00

(52) U.S. Cl. 210/323.2; 210/497.01; 210/485

(57) ABSTRACT

A lenticular style of filtration in a first stage and a final filtration in a second stage incorporated into a single filtration housing to provide filtration of liquid suitable for pharmaceutical use where the lenticular style filter is formed by a plurality of cellulose filters stacked on a polypropylene cylindrical mesh support tube having a membrane filter cartridge removably mounted inside the mesh support tube.

### FIELD OF THE INVENTION

The present invention relates to sanitary filtering of liquid for the pharmaceutical industry, chemical plants, hospitals and house hold product packagers, for example, and others requiring completely sterile conditions for production of a sanitary product.

### BACKGROUND OF THE INVENTION

Traditionally, filtration of liquids used in the pharmaceutical industry, for example, where sterility of the fluid must be assured, requires the repeated filtration of the liquid through several interconnected filter housings. Each filter housing includes a filter and produces a predetermined amount of filtration depending upon the particular filter media used. After successive filtration steps requiring several interconnected filter housings, the filtered liquid may be used in a pharmaceutical process. This process is very expensive and requires sterilization and the maintenance of sterile conditions in multiple filter housings.

Usually, liquid is initially filtered by a cellulose filter in a sealed filter housing. The filtered liquid is then passed downstream through a piping system to at least a second filter housing having a membrane filter for filtration of liquid to a pharmaceutical grade.

Accordingly, there is a long felt need in the industry to reduce the number of steps and equipment required to achieve multiple levels of filtration of a liquid under sterile conditions.

### SUMMARY OF THE INVENTION

By the present invention, liquid is pumped into a filter housing and passed through a cellulose filter which filters materials greater than one micron in size. The filtered liquid passes through a polypropylene cylindrical mesh support tube and into a centrally located membrane filter cartridge. The membrane filter cartridge removes particulate matter greater than 0.5 microns in size. Other combinations of filtration efficiency may be made by the customer, according to their particular filtration needs.

The filtered liquid passes through the membrane filter cartridge towards its hollow center. The filtered liquid flows by gravity, outside of the filter housing for further processing and/or use. Optionally, the liquid to be filtered may be moved in an opposite direction, passing initially through the membrane filter cartridge and radially outward to be filtered by a cellulose filter or other filter cartridge.

The polypropylene cylindrical mesh support tube accommodates the easy insertion and removal of a premade membrane filter cartridge or other filter cartridge in a reverse direction filtration. After the useful life of the filter cartridge is over, the filter cartridge can easily be removed and replaced.

This assembly facilitates the use by a customer of two different filter suppliers. One supplier may provide the cellulose filters mounted on the polypropylene cylindrical mesh support tube. A second supplier may be used to provide pre-formed membrane filter cartridges which are easily removed and replaced by the slidable mounting of the filter cartridge in the support tube.

The cylindrical mesh support tube is dimensioned to accommodate a particular diameter of membrane filter cartridge so that the exterior of the filter cartridge engages the interior of the cylindrical mesh tube. Thereby, liquid is communicated directly from the cellulose filters to the filter cartridge for complete and thorough filtration.

Accordingly, it is an object of the present invention to provide a lenticular style of filtration in a first stage and a final filtration in a second stage incorporated into a single filtration housing to provide filtration of liquid suitable for pharmaceutical use.

It is another object of the present invention to provide a lenticular style of filtration in a first stage and a final filtration in a second stage incorporated into a single filtration housing to provide filtration of liquid suitable for pharmaceutical use where the lenticular style filter is formed by a plurality of cellulose filters stacked on a polypropylene cylindrical mesh support tube having a membrane filter cartridge slidably and removably mounted inside the mesh support tube.

It is still yet another object of the present invention to provide a lenticular style of filtration in a first stage and a final filtration in a second stage incorporated into a single filtration housing to provide filtration of liquid suitable for pharmaceutical use where the lenticular style filter is formed by a plurality of cellulose filters stacked on a polypropylene cylindrical mesh support tube having a membrane filter cartridge slidably and removably mounted inside the mesh support tube with the liquid to be filtered passing through the cellulose filters and radially inwardly through the mesh openings of the support tube and into a hollow interior of the filter cartridge after passing through the filter media of the cartridge.

It is still yet another object of the present invention to provide a lenticular style of filtration in a first stage and a final filtration in a second stage incorporated into a single filtration housing to provide filtration of liquid suitable for pharmaceutical use where the lenticular style filter is formed by a plurality of cellulose filters stacked on a polypropylene cylindrical mesh support tube having a membrane filter cartridge slidably and removably mounted inside the mesh support tube with the liquid to be filtered passing through the cellulose filters and radially inwardly through the mesh openings of the support tube and into a hollow interior of the filter cartridge after passing through the filter media of the cartridge or optionally passing from the interior of the filter cartridge radially outwardly through the filter cartridge, the support tube and the plurality of cellulose filters.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is an exploded view of the two stage filtration of the present invention illustrating a membrane filter cartridge to be slidably and frictionally mounted within a polypropylene cylindrical mesh support tube.

FIG. 2 is a partial cross-sectional view illustrating the mounting of a cylindrical mesh support tube inside of a stainless steel filter housing with a membrane filter cartridge slidably mounted inside the support tube and a plurality of cellulose filters mounted exteriorly of the cylindrical mesh support tube so as to provide a flow path from the cellulose filters through-the support openings of the support tube and into the membrane filter cartridge to pass filtered liquid through an outlet pipe of the filter housing.

FIG. 3 is an enlarged partial cross-sectional view illustrating the mounting of the support tube in the filter housing.

FIG. 4 illustrates an exploded view of an alternate embodiment of a cylindrical mesh support tube.

FIG. 5 is an enlarged cross-sectional view of the bottom end of the mesh support tube shown in FIG. 4.

FIG. 6 is a cross sectional view taken along line 6-6 of FIG. 1 to illustrate the construction of the filter cartridge.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

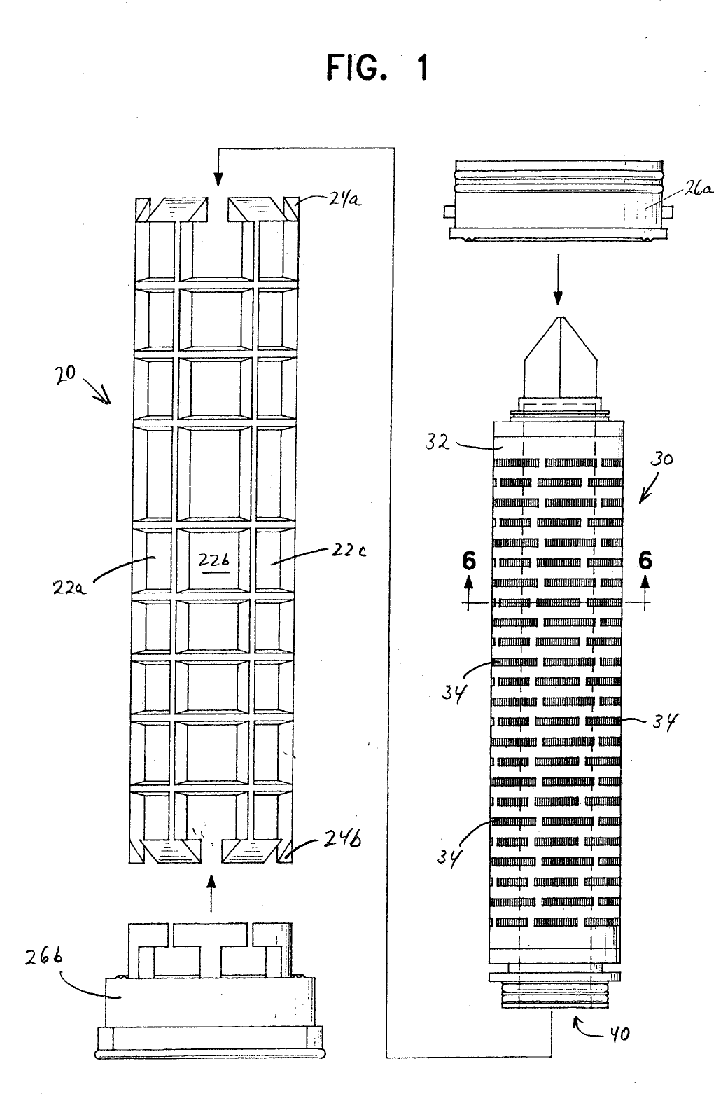

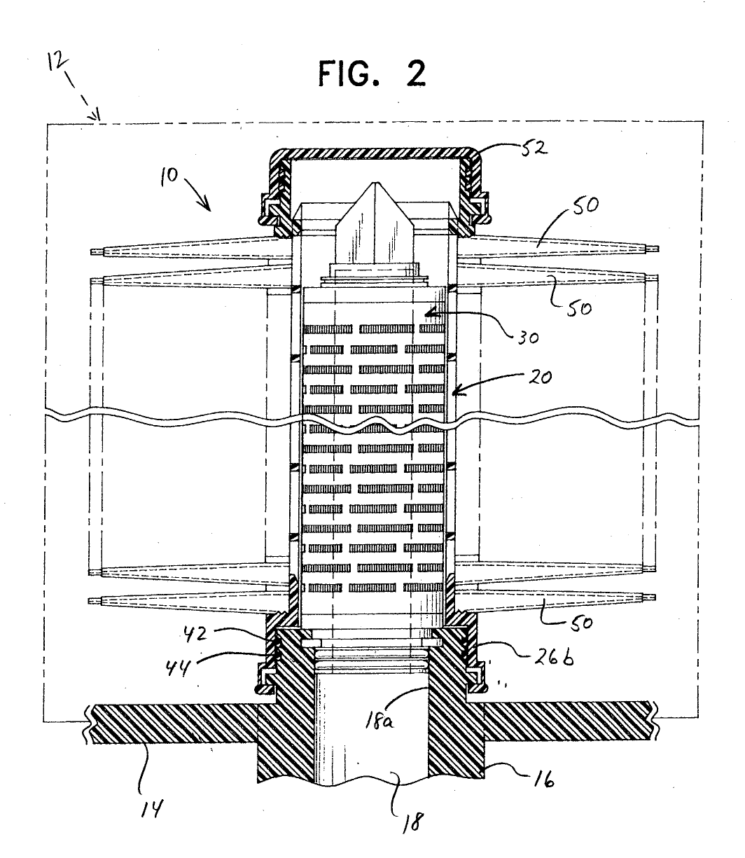

With reference to the drawings, in general, and to FIGS. 1 and 2, in particular, a unitary two stage filtration system embodying the teachings of the subject invention is generally designated as 10. With reference to its orientation in FIG. 2, the filtration system 10 is mounted within a stainless steel filter housing 12 illustrated by dotted lines. A base plate 14 of the housing includes an outlet pipe 16 passing therethrough having a hollow interior channel 18.

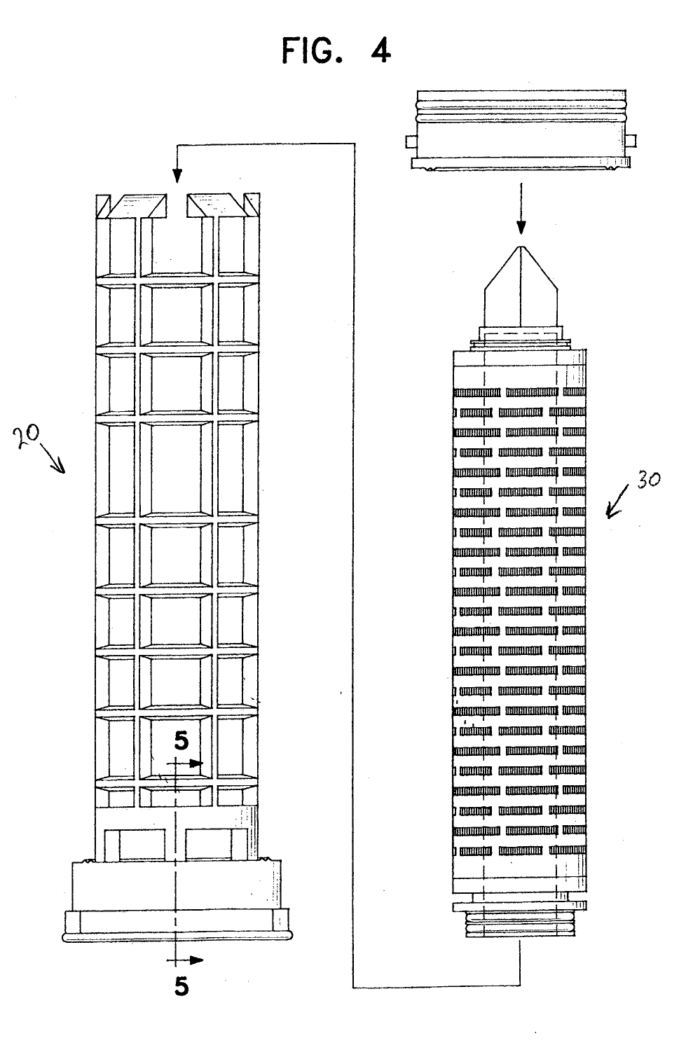

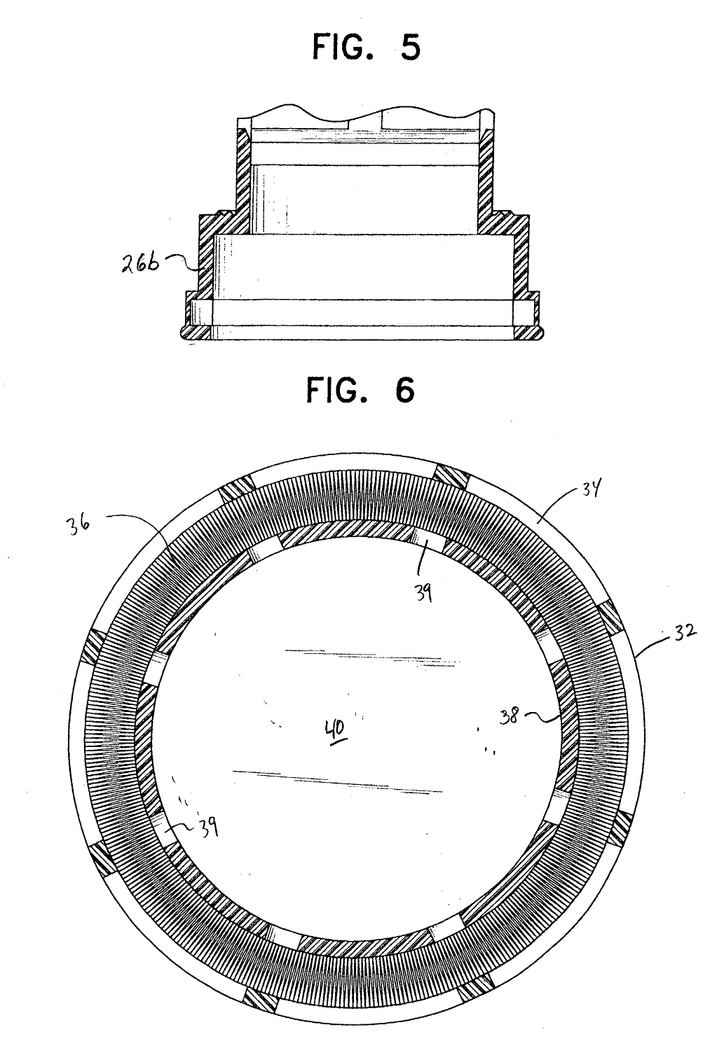

Mounted in the housing 12 is a polypropylene cylindrical mesh support tube 20 as shown in FIG. 1. Spaced along the length of the tube are a plurality of openings, 22a, 22b, 22c, . . . , for example. At opposite ends 24a, 24b are mounted end caps 26a, 26b. End caps 26a, 26b are shown removed from the tube 20 in FIG. 1. It is understood as being within the scope of the present invention that one end cap may be integral at one end of the tube 20 as shown in FIG. 4.

Slidably and frictionally mounted in the interior of the tube 20 is a membrane filter cartridge 30. The filter cartridge 30 as shown in FIG. 6, includes an exterior wall 32 having a plurality of openings 34. The openings 34 expose interior paper or other filter material 36 which is repeatedly folded upon itself between exterior wall 32 and interior wall 38. Interior wall openings 39 lead to a hollow passageway 40 extending along the length of the cartridge 30.

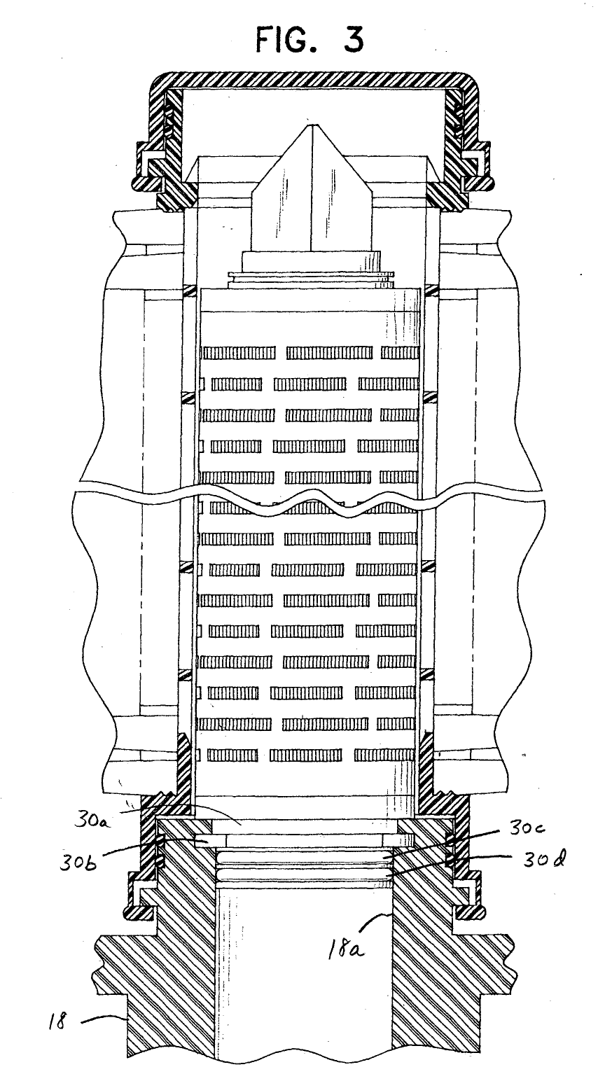

When the tube 20 and the filter cartridge 30 are mounted inside a filter housing as shown in FIGS. 2 and 3, one end cap 26b fits over and around an upper end 18a of outlet tube 18. O-rings 42, 44 assist in sealing the connection between the end cap 26b and the end 18a of the outlet tube 18. Alternative arrangements for securing the tube 20 to the outlet tube 18 may be made and are considered to be within the scope of the present invention. An example of a filter housing is shown in U.S. Pat. No. 5,443,720, hereby incorporated in its entirety by reference.

As shown in FIG. 2, the filter cartridge 30 is located inside the support tube 20. Mounted on the exterior of the tube 20 are a plurality of cellulose filter cells 50. An example of one such filter cell is shown in U.S. Pat. No. 5,316,678, hereby incorporated in its entirety by reference. The filter cells 50 extend along the length of the support tube between its end caps. A cover cap 52 closes off the end of the support tube 20 opposite to the end mounted on the outlet tube 18.

End 30a of the filter cartridge may, by a bayonet extension 30b, be locked in the end 18a of the outlet tube. O-rings 30c, 30d assist in sealing the filter cartridge 30 to the outlet tube 18 to provide a path for filtered liquid passing from the hollow passageway 40 of the filter cartridge to the filter outlet tube 18. Alternatively, the filter cartridge may be inverted with both O-rings at the top or one O-ring at the bottom and one O-ring at the top.

Accordingly, liquid to be filtered is passed into the interior of the filter housing and after passing through the filter cells 50 the first stage filtered liquid passes through the openings in the support tube and then into the filter cartridge. The second stage filtered liquid is passed through the outlet tube 18 for further processing.

Optionally, the flow of liquid may be in a reverse direction by entering the filter housing through tube 18 and passing radially outwardly through the filter cartridge or other filter media and through the filter cells into the interior of the filter housing for subsequent processing. Under either scenario, the filter cartridge may be slidably removed and easily replaced, as necessary. The plurality of filter cells are also slidably mounted on the support tube for removal and replacement. The assembly of the present invention provides two stage filtration in a single filter housing while including the use of a slidably mounted, frictionally held, pre-assembled filter cartridge having interior and exterior walls with filter media therebetween.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

We claim:

1. A filtration system comprising:
a support tube for mounting in a filter housing,
a plurality of filter cells mounted on said support tube, and
a filter cartridge slidably mounted in said support tube.

2. The filtration system as claimed in claim 1, wherein said filter cartridge includes a rigid outer wall and a rigid inner wall with filter media therebetween.

3. The filtration system as claimed in claim 1, wherein said support tube includes a plurality of openings for passage therethrough of liquid being filtered by said filter cells and said filter cartridge.

4. The filtration system as claimed in claim 1, wherein said filter cartridge is sealingly engaged, at least at one end, with said support tube.

5. The filtration system as claimed in claim 1, wherein a filterability of said filter cells is different from a filterability of said filter cartridge.

6. The filtration system as claimed in claim 1, wherein one end of said support tube is sealed against liquid flow.

7. The filtration system as claimed in claim 3, wherein said support tube is made of polypropylene.

8. A filter assembly comprising:
a filter housing having an inlet and an outlet, and
a support tube positioned adjacent to the outlet for supporting two different filter media internally of and externally of said support tube, said support tube including a plurality of openings in a side wall and being open at one end, said one end being connected to said outlet.

9. The filter assembly as claimed in claim 8, wherein a plurality of filter cells are mounted on said support tube and a filter cartridge is slidably mounted in said support tube.

10. The filter assembly as claimed in claim 9, wherein said filter cartridge includes a rigid outer wall and a rigid inner wall with filter media therebetween.

11. The filter assembly as claimed in claim 9, wherein said filter cartridge is sealingly engaged, at least at one end, with said support tube.

12. The filter assembly as claimed in claim 9, wherein one end of said support tube is sealed against liquid flow.

13. The filter assembly as claimed in claim 8, wherein said support tube is made of polypropylene.
